(19) United States
(12) Patent Application Publication
(10) Pub. No.: US 2025/0272964 A1
(43) Pub. Date: Aug. 28, 2025

(54) COMPUTER SYSTEM AND ACTIVE LEARNING METHOD THEREOF

(71) Applicant: LITE-ON TECHNOLOGY CORPORATION, TAIPEI CITY (TW)

(72) Inventors: TseChun WANG, TAIPEI CITY (TW); Hsuan Ta LIN, TAIPEI CITY (TW)

(21) Appl. No.: 18/944,631

(22) Filed: Nov. 12, 2024

Related U.S. Application Data
(60) Provisional application No. 63/557,629, filed on Feb. 26, 2024.

(51) Int. Cl. G06V 10/778; G06V 10/26

(52) U.S. Cl. CPC G06V 10/7792; G06V 10/26

(57) ABSTRACT

A computer-implemented method for active learning is provided. The method includes steps of using a proxy model to estimate a utility distribution of a raw data pool based on a raw data subset obtained from the raw data pool, determining a selection criterion based on the utility distribution, performing a data selection process based on the selection criterion, and using the training data pool to train the target model. The data selection process involves steps of using the proxy model to calculate a utility score associated with a raw image from the raw data pool, using the selection criterion to selectively provide the raw image to an oracle to obtain a selected image corresponding to the raw image, and incorporating the selected image into the training data pool. The utility score associated with the raw image provided to the oracle meets the selection criterion.

### CROSS REFERENCE TO RELATED APPLICATIONS

This application claims the benefit of U.S. Provisional Application No. 63/557,629, filed Feb. 26 2024, the entirety of which is incorporated by reference herein.

### BACKGROUND OF THE INVENTION

### Field of the Invention

The present invention relates to the field of machine learning, and, in particular, to a computer system and the active learning method thereof.

### Description of the Related Art

Active learning is a machine learning (ML) training method that is particularly valuable for training computer vision-related models. In traditional supervised training processes, labeling large datasets is often expensive and time-consuming, especially in computer vision where datasets are massive and complex. Active learning aims to reduce the labeling effort by selecting only the most valuable data to be labeled, thereby accelerating the model training process. The core idea of active learning is that the model can interact with an information source known as an oracle, which is typically a human annotator or an automated labeling system, to request labels for data points where the model's predictions are uncertain or where the data holds high value for improving the model.

The key challenge of active learning lies in determining which data should be provided to the oracle for labeling. Therefore, data selection plays a critical role within active learning. The purpose of data selection is to speed up the model training process while preventing the model from learning low-quality data, which can lead to decreased accuracy. By selecting the right data to be labeled, the active learning pipeline can significantly enhance the efficiency of model training, allowing the model to achieve high accuracy more quickly.

In active learning, data is typically selected in batches, with the process alternating between training the model and selecting new data for labeling. This iterative process continues until the selected data reaches the budget specified by the developer. A key factor in this process is the data selection, which must be based on the utility of the data. In traditional active learning systems, the utility scores for data points are recalculated in each batch. This repeated calculation of utility scores can be extremely costly in computational resources, especially when dealing with large datasets. Regardless of how the utility score is formulated, traditional methods struggle to achieve significant breakthroughs in computational efficiency over the course of the entire model training process. The repeated calculation of utility scores for every new batch, coupled with large data volumes, presents a major bottleneck in the overall efficiency of active learning.

Therefore, there is a need for a method to cure the inefficiencies in active learning.

### BRIEF SUMMARY OF THE INVENTION

An embodiment of the present invention provides a computer-implemented method for active learning. The method includes steps of using a proxy model to estimate a utility distribution of a raw data pool based on a raw data subset obtained from the raw data pool, determining a selection criterion based on the utility distribution, performing a data selection process based on the selection criterion, and using the training data pool to train the target model. The data selection process involves steps of using the proxy model to calculate a utility score associated with a raw image from the raw data pool, using the selection criterion to selectively provide the raw image to an oracle to obtain a selected image corresponding to the raw image, and incorporating the selected image into the training data pool. The utility score associated with the raw image provided to the oracle meets the selection criterion.

In an embodiment, the step of using the proxy model to estimate the utility distribution of the raw data pool further includes inputting each raw image in the raw data subset into the proxy model to calculate the utility score associated with that raw image, and estimating the utility distribution of the raw data pool based on the utility scores associated with the raw images in the raw data subset. Additionally, the step of determining the selection criterion further includes deriving a cumulative distribution from the utility distribution, and using the cumulative distribution to determine the selection criterion which is associated with a first specified proportion.

In an embodiment, the data selection process includes a first selection procedure that is performed for at least two iterations based on the selection criterion. Each iteration of the first selection procedure involves steps of sampling the raw image from the raw data pool, inputting the raw image into the proxy model to calculate the utility score associated with the raw image, checking if the utility score associated with the raw image meets the selection criterion, and providing the raw image to the oracle to obtain the corresponding selected image and incorporate the selected image into the training data pool if so. The steps of sampling the raw image, calculating the utility score for the raw image, and checking if the utility score associated with the raw image meets the selection criterion are repeated until number of the selected images incorporated into the training data pool in that iteration of first data selection process reaches a specified budget. Before entering next iteration of the first selection procedure, the proxy model is retrained using the training data pool.

In an embodiment, the data selection process further involves using the cumulative distribution to determine an exclusion criterion associated with a second specified proportion. Additionally, each iteration of the first selection procedure further involves checking if the utility score associated with the raw image that does not meet the selection criterion meets the exclusion criterion, excluding the raw image if so, and incorporating the raw image into a candidate dataset as a candidate image if not.

In an embodiment, the data selection process further includes a second selection procedure that is performed for at least two iterations. Each iteration of the second selection procedure involves steps of inputting each candidate image in the candidate dataset into the proxy model to calculate the utility score associated with that candidate image, ranking the utility scores associated with the candidate images in the candidate dataset, and selecting, based on the ranking of the utility scores associated with the candidate images, a specified number of candidate images with lowest utility scores to provide to the oracle to obtain the corresponding selected images, and incorporating the selected images into the training data pool. Before entering next iteration of the second selection procedure, the proxy model is retrained using the training data pool.

In an embodiment, the proxy model comprises a dropout layer which randomly omits each neuron with a specified dropout probability. Additionally, the utility score is calculated based on multiple outputs across multiple forward passes of the proxy model.

In an embodiment, the utility score is calculated based on a combination of semantic certainty, spatial certainty, and occurrence certainty associated with the multiple outputs. The semantic certainty represents the proxy model's confidence in predicting a class of an object, the spatial certainty represents the proxy model's confidence in predicting a spatial extent of the object, and the occurrence certainty represents a frequency of the object's occurrence in the multiple forward passes of the proxy model.

In an embodiment, the spatial certainty is calculated based on a combination of bounding box certainty and mask certainty. The bounding box certainty represents the proxy model's confidence in predicting a bounding box of the object, and the mask certainty represents the proxy model's confidence in predicting instance segmentation of the object. The bounding box certainty is measured by an intersection over union (IOU) between the predicted bounding box and an average bounding box. The mask certainty is measured by the IOU between the predicted instance segmentation and an average instance segmentation.

In an embodiment, the raw data subset is obtained from the raw data pool through simple random sampling.

An embodiment of the present invention provides a computer system for active learning. The computer system includes a processing unit and a storage unit. The storage unit is configured to store a raw data pool, a training data pool, and an active learning program. The active learning program includes instructions that, when executed by the processing unit, cause the computer system to execute the above-described method for active learning.

The active learning method provided herein offers a significant improvement in computational efficiency by leveraging the evaluation of the utility distribution to establish selection and/or exclusion criteria. As a result, the need to repeatedly calculate utility scores of raw images is drastically reduced, allowing for more efficient data selection while maintaining model performance. According to experimental results, this method improves efficiency by at least 27% compared to traditional active learning methods, without compromising model accuracy. The flexibility in defining and applying the selection and/or exclusion criteria further enhances the adaptability to various machine learning tasks, providing an efficient and robust solution for active learning pipelines.

### BRIEF DESCRIPTION OF THE DRAWINGS

The present invention can be more fully understood by reading the subsequent detailed description and examples with references made to the accompanying drawings, wherein:

FIG. 1 illustrates the data flow of a typical active learning method;

FIG. 2 is the system block diagram of a computer system for active learning, according to an embodiment of the present disclosure;

FIG. 3A is the flow diagram of an active learning method, according to an embodiment of the present disclosure;

FIG. 3B is the flow diagram of a data selection process, which is involved in a certain step of the active learning method;

FIG. 3C illustrates the corresponding data flow of the active learning method;

FIG. 4A and FIG. 4B are flow diagrams presenting further operations of certain steps of the active learning method, respectively, according to an embodiment of the present disclosure;

FIG. 5A presents an exemplary probability density plot of the utility distribution, according to an embodiment of the present disclosure;

FIG. 5B presents an exemplary cumulative distribution plot corresponding to the probability density plot;

FIG. 6 is the flow diagram of a first selection procedure involved in the data selection process, according to an embodiment of the present disclosure;

FIG. 7A is the flow diagram of the first selection procedure, and FIG. 7B illustrates the corresponding data flow of the first selection procedure, according to another embodiment of the present disclosure; and

FIG. 8 is the flow diagram of a second selection procedure involved in the data selection process, according to a further embodiment of the present disclosure.

### DETAILED DESCRIPTION OF THE INVENTION

The following description is made for the purpose of illustrating the general principles of the invention and should not be taken in a limiting sense. The scope of the invention is best determined by reference to the appended claims.

In each of the following embodiments, the same reference numbers represent identical or similar elements or components.

It must be understood that the terms “including” and “comprising” are used in the specification to indicate the existence of specific technical features, numerical values, method steps, process operations, elements and/or components, but do not exclude additional technical features, numerical values, method steps, process operations, elements, components, or any combination of the above.

Ordinal terms used in the claims, such as “first,” “second,” “third,” etc., are only for convenience of explanation, and do not imply any precedence relation between one another.

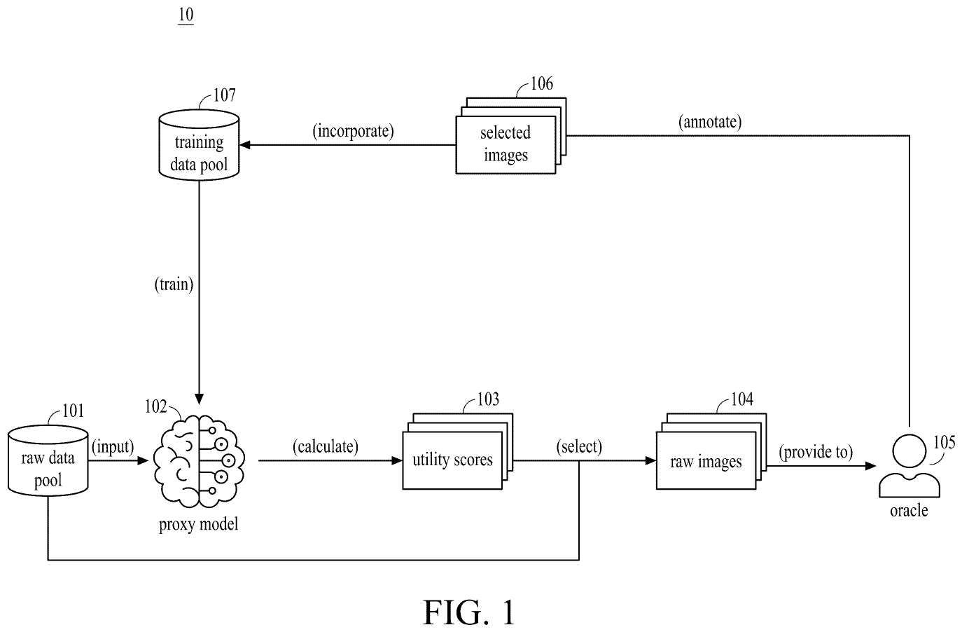

FIG. 1 illustrates the data flow of a typical active learning method 10. In this method 10, raw images in the raw data pool 101 are provided as input to a proxy model 102, which is used for calculating the utility scores 103 associated with these raw images. These utility scores 103 represent the potential value or importance of the raw images for training the target model. Next, the utility scores 103 are ranked, and a subset of raw images 104 is selected based on the ranking of the utility scores 103 and provided to an oracle 105. The oracle 105 annotates the raw images 104, for example, by labeling them with the correct class or other information, depending on the type of task. Hereinafter, the annotated images are referred to as “selected images.” The selected images 106 are incorporated into the training data pool 107, and the proxy model 102 is retrained using this updated training data pool 107. The above process is iteratively executed until the accumulated number of selected images 106 within the training data pool 107 reaches the budget specified by the developer.

One of the key challenges of the active learning method 10 lies in the performance bottleneck caused by the iterative calculation of utility scores 103 for the raw data pool 101. Specifically, as the training process continues, the utility score calculations are repeatedly performed for the same data points across multiple iterations, which leads to a significant computational burden. This issue becomes particularly severe when dealing with large raw data pool 101 or calculating utility scores 103 using complex algorithms.

In view of the problems of the active learning method 10, the approach to active learning has been redefined. The present disclosure aims to optimize the active learning pipeline by first estimating the utility score distribution of the entire raw data pool in advance using a raw data subset that is relatively small in size, and then determining a selection criterion based on this estimated distribution. This reduces the need for repeated utility score calculations and improves the overall efficiency of the active learning pipeline.

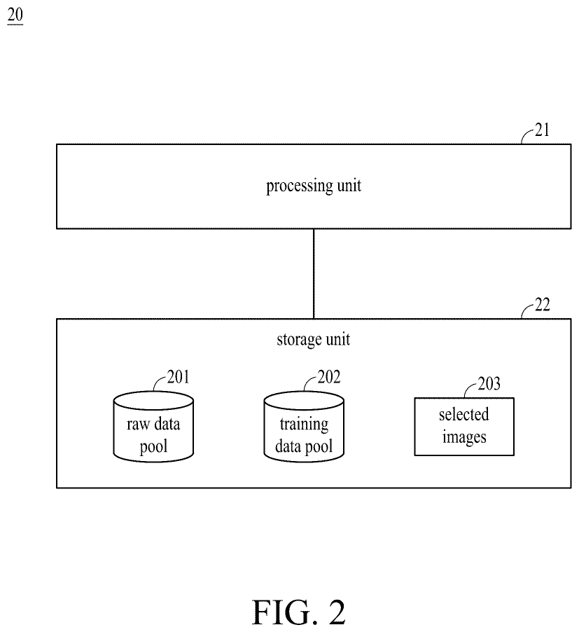

FIG. 2 is the system block diagram of a computer system 20 for active learning, according to an embodiment of the present disclosure. As shown in FIG. 2, the computer system 20 includes a processing unit 21 and a storage unit 22, each of which will be introduced hereinafter.

The computer system 20 can be a personal computer (such as a desktop or laptop computer) or a server computer running an operating system (such as Windows, Mac OS, Linux, UNIX, among others). Alternatively, the computer system 20 can also be a mobile device such as a tablet or smartphone, but the present disclosure is not limited thereto.

The processing unit 21 may include one or more general-purpose or specialized processors, or a combination thereof, capable of executing instructions. The processing unit 21 may further include volatile memory such as Random Access Memory (RAM), Dynamic Random Access Memory (DRAM), and/or other types of high-speed memory, which work in conjunction with the processors to store and quickly access data and instructions during execution.

In an embodiment, the processing unit 21 includes a Central Processing Unit (CPU) and a Graphics Processing Unit (GPU). A GPU is specifically designed to perform computer graphics calculations and image analysis, making it more efficient for these tasks compared to a general-purpose CPU. Therefore, tasks may be assigned based on the characteristics of the CPU and GPU, such as assigning tasks related to data acquisition or communication with other devices to the CPU and tasks related to computer graphics calculations and image analysis to the GPU. In further embodiments, the processing unit 21 may further include a Neural Processing Unit (NPU), which is optimized for deep learning. Compared to a GPU, an NPU may offer superior computational performance for tasks related to the training and inference of a deep learning model. Therefore, in this embodiment, operations involving model training and inference can be assigned to the NPU to achieve improved efficiency and performance.

The storage unit 22 may include one or more non-transitory computer-readable storage media that contain non-volatile memory, such as read-only memory (ROM), electrically-erasable programmable read-only memory (EEPROM), flash memory, or non-volatile random access memory (NVRAM). These storage media may include, but are not limited to, hard disk drives (HDD), solid-state drives (SSD), optical disks, or any combination thereof.

As shown in FIG. 2, the storage unit 22 is used for storing a raw data pool 201, a training data pool 202, and an active learning program 203, each of which will be introduced hereinafter.

The raw data pool 201 stores raw images that have not been labeled or annotated. These images serve as the basis for the active learning pipeline, where data selection is performed. Images selected from the raw data pool 201 are provided to the oracle for labeling. Once labeled, these images are transferred to the training data pool 202. The images in the training data pool 202, referred to as selected images, are annotated with relevant information based on the task at hand. For instance, labels may include bounding boxes that define the spatial extent of objects in the image or object categories that specify what is present in the image (e.g., cat, dog, car). As the active learning pipeline progresses, the training data pool 202 grows incrementally, accumulating a more diverse and representative set of labeled data. This increasingly enriched training data pool 202 is used to train the model, improving its accuracy and robustness with each iteration.

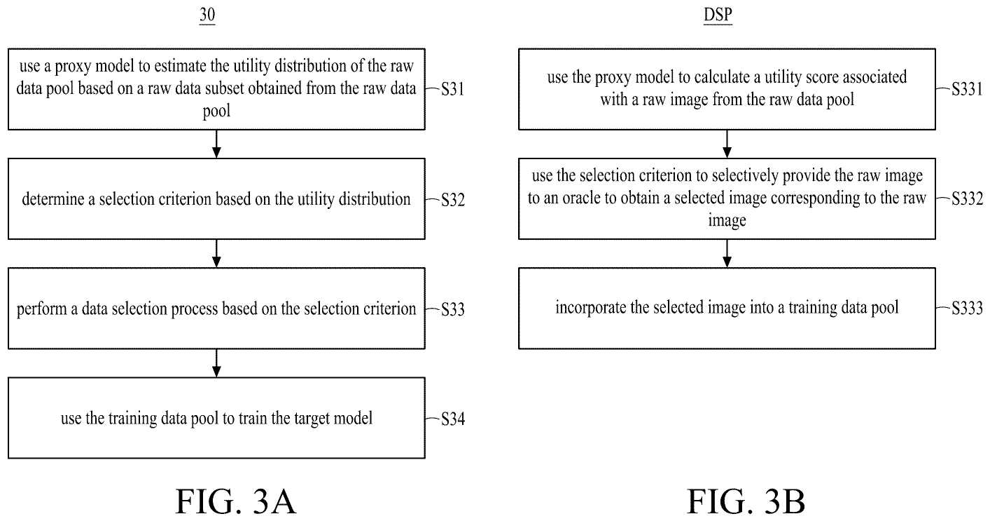

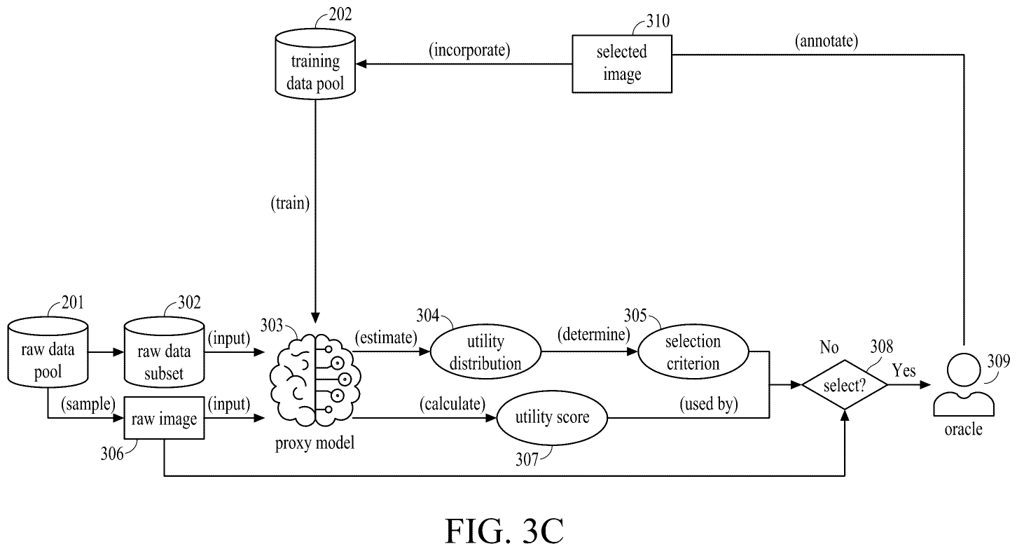

The active learning program 203 is a computer-executable program, which can be written in any known programming language, such as Python, C++, or Java. The active learning program 203 contains instructions that, when executed by the processing unit 21, cause the computer system 20 to perform the steps of an active learning method. The details of this active learning method, particularly including how data is selected, will be elaborated with reference to FIGS. 3A-3C hereinafter. In general, the active learning program 203 enables the computer system 20 to coordinate the interactions between the raw data pool 201, the oracle, and the training data pool 202, facilitating an iterative process that incrementally improves the model's accuracy while minimizing computational resources.

FIG. 3A is the flow diagram of an active learning method 30, according to an embodiment of the present disclosure. As shown in FIG. 3A, the active learning method 30 includes steps S31-S34. FIG. 3B is the flow diagram of a data selection process DSP, which is involved in step S33 of the active learning method 30. FIG. 3C illustrates the corresponding data flow of the active learning method 30. In view of the strong correlation between FIGS. 3A-3C, it is recommended to refer to FIGS. 3A-3C collectively for a clearer understanding of this embodiment.

In step S31, proxy model 303 is used to estimate the utility distribution 304 of the raw data pool 201 based on a raw data subset 302 obtained from the raw data pool 201. Then, the active learning method 30 proceeds to step S32.

The raw data pool 201 stores raw images that have not been labeled or annotated. These images serve as the basis for the active learning pipeline, where data selection is performed. The raw data subset 302 is a smaller set of images sampled from the raw data pool 201. Like the raw data pool 201, the images in the raw data subset 302 do not have any labels or annotations. In an embodiment, the raw data subset 302 is obtained from the raw data pool 201 through simple random sampling. Simple random sampling helps provide an unbiased and representative subset of the overall raw data pool 201, ensuring that the utility distribution estimated from this subset (i.e., raw data subset 302) accurately reflects the utility distribution of the entire raw data pool 201. However, the sampling approach used to obtain the raw data subset 302 is not limited herein. In other embodiments, other sampling techniques may be used, such as stratified sampling, systematic sampling, or cluster sampling, depending on the specific characteristics of the data and the objectives of the model.

The proxy model 303 serves as a preliminary model that simulates the behavior of the eventual target model, but it is typically lighter and faster to compute, allowing it to efficiently perform utility score evaluation. In the context of active learning, the proxy model 303 is iteratively refined through the training process. While the target model is the ultimate goal of the training process, the proxy model 303 helps streamline the whole active learning pipeline by reducing computational costs, while still guiding the data selection process in a way that benefits the eventual performance of the target model. After each iteration, data from the training data pool 202 is used to retrain the proxy model 303, progressively improving its alignment with the target model's objectives.

The utility distribution 304 represents the relative value or importance of each image in the raw data pool 201 with respect to its potential contribution to improving the accuracy of the target model. Utility of each image can be evaluated using various measures, such as the certainty/uncertainty of the model's prediction for that image, the diversity of the image compared to others in the dataset, or its representativeness in terms of covering underrepresented areas of the feature space.

Specifically, when the certainty of the model's prediction for an image is high, it indicates that the model is confident in its prediction of the image. While this seems to be a positive outcome, it may suggest that the image has less value for training as it may not provide new learning opportunities for the model. On the other hand, when the certainty is low, it suggests that the model is uncertain about its prediction, meaning that the image could provide significant training value. Therefore, images with low certainty might have higher utility, as they can help the model improve on more challenging or ambiguous cases.

For diversity, if an image is highly diverse compared to others in the dataset, it may cover a different aspect of the feature space, introducing new patterns or characteristics that the model has not yet encountered. This can increase the training value of the image. Conversely, if the image is similar to many others in the dataset, it may provide less additional value for training since the model may already be well-versed in similar cases. Thus, images with higher diversity might have higher utility, as they enrich the dataset with new information.

Regarding representativeness, images that capture rare or insufficiently covered features or patterns in the dataset are considered to represent underrepresented areas of the feature space. These images are crucial for improving the model's ability to generalize, as they help the model learn from a broader range of scenarios. Therefore, images that fill gaps in the feature space, especially those covering rare or less frequent features, have higher utility as they ensure a more comprehensive learning process for the model.

In step S32, selection criterion 305 is determined based on the utility distribution 304. Then, the active learning method 30 proceeds to step S33.

The selection criterion 305 serves as a guiding metric for evaluating and deciding which raw images from the raw data pool 201 should be selected for further processing. This criterion is used to systematically prioritize certain raw images over others. By applying the selection criterion, the active learning method 30 ensures that the most valuable or informative raw images, according to the defined utility metrics, are chosen for subsequent labeling and training. The specific details and conditions for how the selection criterion 305 is applied will be further elaborated hereinafter.

In step S33, data selection process DSP is performed based on the selection criterion 305. As shown in FIG. 3B, the data selection process DSP involves step S331-S333, each of which will be elaborated hereinafter.

In step S331, the proxy model 303 is used to calculate the utility score 307 associated with a raw image 306 from the raw data pool 201. This raw image 306 can also be obtained through simple random sampling from the raw data pool 201, but the present disclosure is not limited thereto. Then, the data selection process DSP proceeds to step S332.

It should be noted that the utility score is not the direct inference target of the proxy model 303. In other words, the proxy model 303 does not directly output a utility score. Instead, the utility score is derived from the predictions or inference made by the proxy model 303. This derivation can involve factors such as the confidence or uncertainty of the model's prediction for each raw image, or other metrics such as the above-mentioned diversity and representativeness, which reflect the potential contribution of the image to improving the model's performance.

In step S332, the selection criterion 305 is used to selectively provide the raw image 306 to the oracle 309 to obtain the selected image 310 corresponding to the raw image 306. Then, the data selection process DSP proceeds to step S333.

From the aspect of the data flow as shown in FIG. 3C, a decision 308 is made on whether to provide the raw image 306 to the oracle 309. Specifically, if the utility score 307 associated with the raw image 306 meets the selection criterion 305, indicating that the raw image 306 is expected to make a valuable contribution to the training of the target model once annotated, therefore the decision 308 is to provide the raw image 306 to the oracle 309 for annotation. Conversely, if the utility score 307 does not meet the selection criterion 305, the raw image 306 can be either excluded or temporarily retained for further consideration in future selection rounds. In summary, the utility score 307 associated with the raw image 306 provided to the oracle 309 meets the selection criterion 305.

The oracle 309 serves as the source responsible for labeling or annotating the raw image 306, which generates the corresponding selected image 310. Specifically, the oracle 309 determines the appropriate label or annotation for the raw image 306 selected by decision 308. In an implementation, the oracle 309 can be a human annotator, who manually reviews the raw image 306 and assigns the appropriate labels, such as object categories, bounding boxes, or segmentation masks. In an alternative implementation, the oracle 309 can be an automated labeling system, leveraging machine learning models or rule-based algorithms to automatically generate annotations for the raw image 306. In some other implementations, a combination of both human and automated systems may be used, with the automated system generating initial annotations, and a human annotator refining or verifying the results to ensure accuracy.

In step S333, the selected image 310 is incorporated into the training data pool 202. It should be appreciated that the selected image 310 does not necessarily need to be incorporated into the training data pool 202 one by one. Instead, steps S331 and S332 can be repeatedly executed to evaluate multiple raw images 306, and after accumulating a certain number of selected images 310, they can be incorporated into the training data pool 202 all at once.

It should be noted that the data selection process DSP may include multiple iterations of steps S331-S333. In addition, the data selection process DSP may involve further operations, which will be elaborated hereinafter. Once the entire data selection process DSP is completed, the active learning method 30 proceeds to step S34, where the training data pool 202 is used to train the target model.

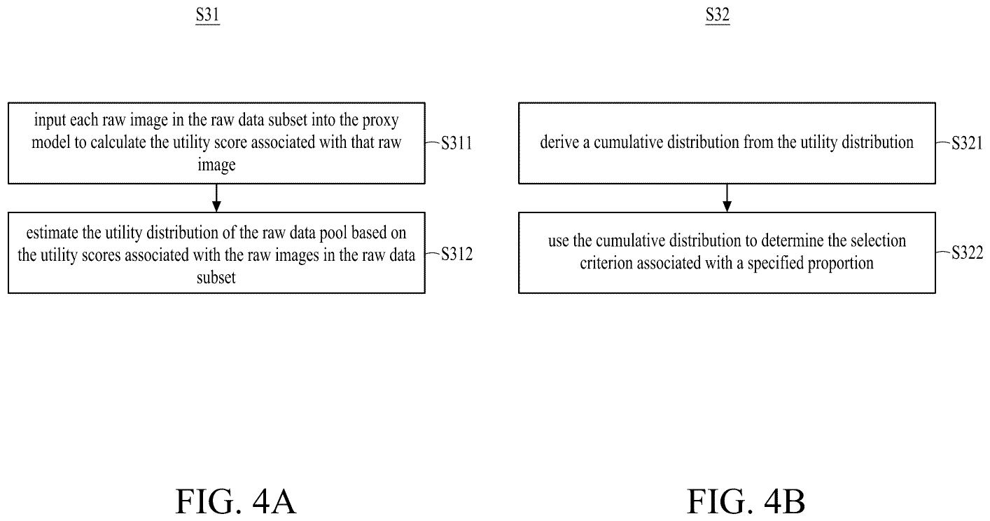

FIG. 4A and FIG. 4B are flow diagrams presenting further operations of steps S31 and S32, respectively, according to an embodiment of the present disclosure. As shown in FIG. 4A and FIG. 4B, step S31 may involve steps S311 and S312, while step S32 may involve steps S321 and S322.

In step S311, each raw image in the raw data subset 302 is inputted into the proxy model 303 to calculate the utility score associated with that raw image. Then, in step S312, the utility distribution 304 of the raw data pool 201 is estimated based on the utility scores associated with the raw images in the raw data subset 302.

In step S321, a cumulative distribution is derived from the utility distribution 304. Then, in step S322, the cumulative distribution is used to determine the selection criterion 305 associated with a specified proportion.

In this embodiment, the utility distribution 304 and the corresponding cumulative distribution can be represented by a probability density function (pdf) and a cumulative distribution function (cdf), respectively. The probability density function describes the likelihood of different utility scores occurring within the raw data pool 201, indicating how the utility scores are distributed. On the other hand, the cumulative distribution function represents the cumulative probability that a utility score will fall below or be equal to a specific value, allowing the inference of a utility score that corresponds to a specified proportion of the data (e.g., the top 20%). This utility score is then used as the basis for determining the selection criterion 305.

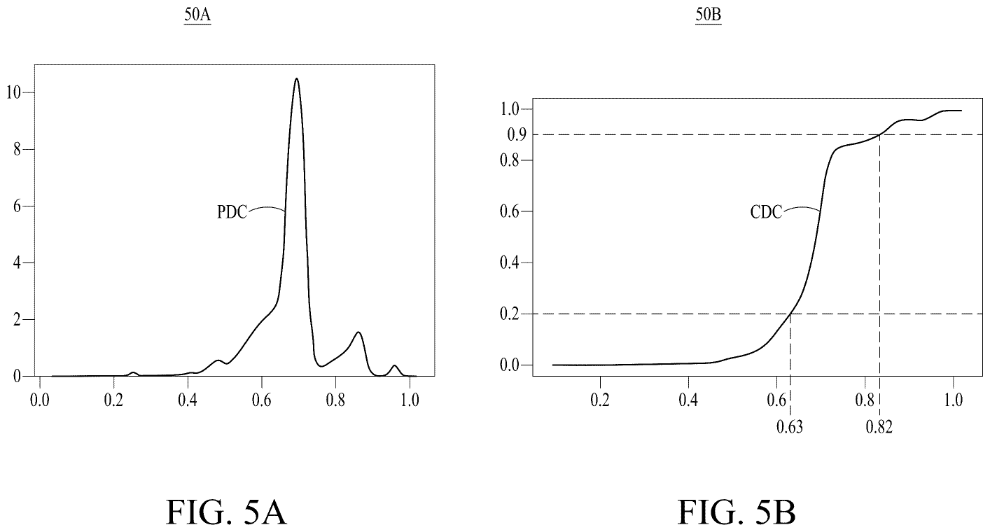

The previously introduced probability density function and cumulative distribution function can be visualized as a probability density plot and cumulative distribution plot, respectively. In other words, the utility distribution 304 and the corresponding cumulative distribution can be visually represented by a probability density plot and cumulative distribution plot, respectively. Further details will be elaborated with reference to FIG. 5A and FIG. 5B hereinafter.

FIG. 5A presents an exemplary probability density plot 50A of the utility distribution 304, according to an embodiment of the present disclosure. In the probability density plot 50A, the probability density curve (PDC) represents the distribution of utility scores for the raw data in the raw data pool 201. The horizontal axis indicates the possible utility scores (ranging from 0 to 1), while the vertical axis represents the density or frequency of those scores within the raw data pool 201. In this example, the PDC shows a notable peak in the range of 0.6 to 0.8, indicating that a large portion of the raw data has utility scores concentrated within this interval.

It should be noted that in this example, certainty is used as the utility score, where higher certainty indicates that the image is less valuable for model improvement. Therefore, in this case, lower utility scores (indicating lower certainty) represent higher potential value or importance for further training.

FIG. 5B presents an exemplary cumulative distribution plot 50B corresponding to the probability density plot 50A. In the cumulative distribution plot 50B, the cumulative distribution curve (CDC) represents the cumulative probability that a given utility score will be less than or equal to a certain value. The horizontal axis represents possible utility scores (ranging from 0 to 1), while the vertical axis represents the cumulative probability. In this example, the specified proportion (referred to in step S322) is set to 0.2, meaning that the goal is to select the top 20% of raw data with the most potential value or importance for training the target model. The CDC shows that a cumulative probability of 0.2 corresponds to a utility score of 0.63. Therefore, the selection criterion 305 can be set as “utility score less than 0.63” to select the most valuable data.

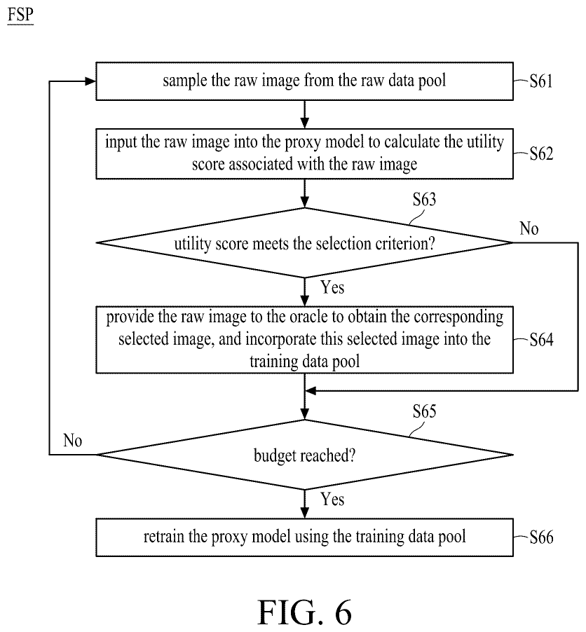

In an embodiment, the data selection process may involve a first selection procedure that is performed for at least two iterations based on the selection criterion. Each iteration of the first selection procedure will be elaborated with reference to FIG. 6.

FIG. 6 is the flow diagram of a first selection procedure FSP, according to an embodiment of the present disclosure. As shown in FIG. 6, each iteration of the first selection procedure FSP includes steps S61-S66. Since some elements involved in these steps are illustrated in FIG. 3C, it is recommended to refer to FIG. 6 and FIG. 3C collectively for a clearer understanding of this embodiment.

In step S61, the raw image 306 is sampled (e.g., through simple random sampling) from the raw data pool 201. Then, the first selection procedure FSP proceeds to step S62.

In step S62, the raw image 306 is inputted into the proxy model 303 to calculate the utility score 307 associated with the raw image 306. Then, the first selection procedure FSP proceeds to step S63.

It is reiterated that the proxy model 303 does not directly output the utility score 307. Instead, the utility score 307 is derived from the predictions or inference made by the proxy model 303.

In step S63, it is checked if the utility score 307 associated with the raw image 306 meets the selection criterion 305. If the utility score 307 meets the selection criterion 305, the first selection procedure FSP proceeds to step S64. If the utility score 307 does not meet the selection criterion 305, the selection procedure FSP skips step S64 and proceeds directly to step S65.

In step S64, the raw image 306 is provided to the oracle 309 for annotation. The oracle 309 labels the raw image 306 to generate the corresponding selected image 310, which is then incorporated into the training data pool 202.

In step S65, it is checked whether the budget for selected images incorporated into the training data pool 202 has been reached. The budget refers to a pre-determined threshold, such as a specified number of selected images or a data annotation limit. If the budget has not been reached, the first selection procedure FSP loops back to step S61 to sample another raw image. If the budget has been reached, the first selection procedure FSP proceeds to step S66.

In step S66, which is the step before entering the next iteration of the first selection procedure FSP, the proxy model 303 is retrained using the newly updated training data pool 202, so as to ensure that the proxy model 303 is continually optimized based on the most recent labeled data. There are two approaches to implement this retraining: incremental retraining, where the model is updated only with the newly added selected images, allowing for faster updates and reduced computational costs; and full retraining, where the entire training data pool 202, including both new and previously labeled data, is used to retrain the proxy model 303 from the ground up, providing a more comprehensive update but with higher computational demands.

It should be appreciated that the first selection procedure FSP is designed to iterate across multiple cycles, each of which involves the steps S61-S66. Additionally, within each iteration, steps S61-S65 form an internal loop where raw images are repeatedly sampled, evaluated, and, if selected, provided to the oracle for annotation. This creates a nested loop structure: the inner loop of S61-S65 continually processes individual raw images until the specified budget is reached, and the outer loop corresponds to multiple iterations of the entire first selection procedure FSP.

Furthermore, the budget involved in step S65 is directly related to the number of iterations in the first selection procedure FSP. For example, if the raw data pool 201 contains 100,000 raw images and the total budget is to select 20%, or 20,000 images, the number of iterations determines how the budget is allocated. If the first selection procedure FSP is set to iterate twice, the budget for each iteration would be 10,000 images (20,000/2). Similarly, if the first selection procedure FSP is set to iterate four times, the budget for each iteration would be 5,000 images (20,000/4), and so on.

In an embodiment, the data selection process further involves using the cumulative distribution to determine an exclusion criterion associated with another specified proportion (different from the other specified proportion referred to in step S322). This exclusion criterion is used to exclude certain raw images from future consideration in the subsequent data selection process.

Refer back to FIG. 5B. In this example, the specified proportion for exclusion is set to 0.9, meaning that the goal is to exclude the bottom 10% of raw data, which is considered to have the least potential value or importance for training the target model. The CDC shows that a cumulative probability of 0.9 corresponds to a utility score of 0.82. Therefore, the exclusion criterion can be set as “utility score higher than 0.82”, meaning any raw image with a utility score higher than 0.82 will be excluded from future consideration, as these images are deemed to have lower training value based on their higher certainty.

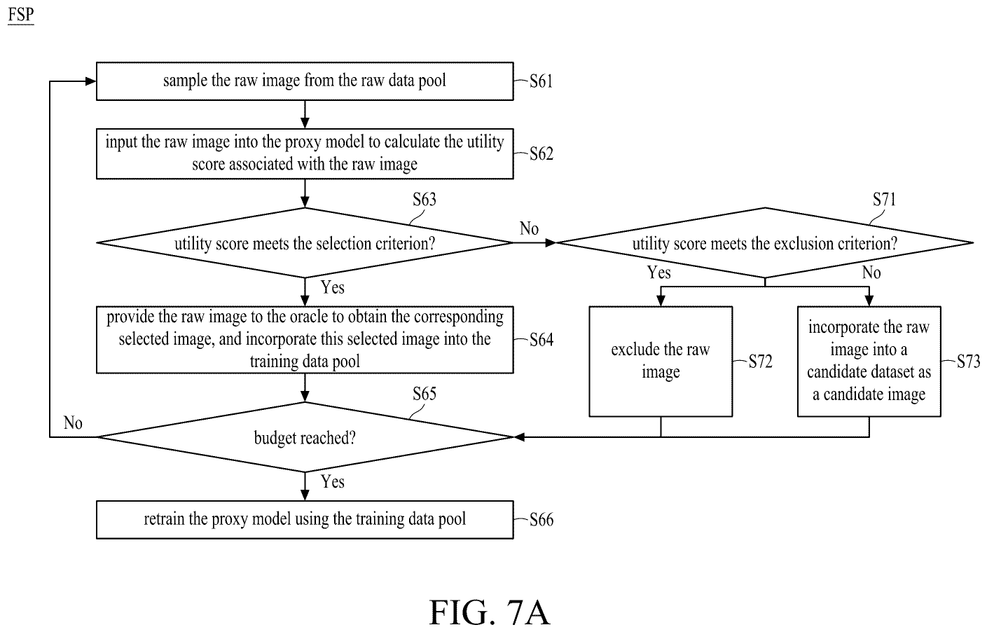

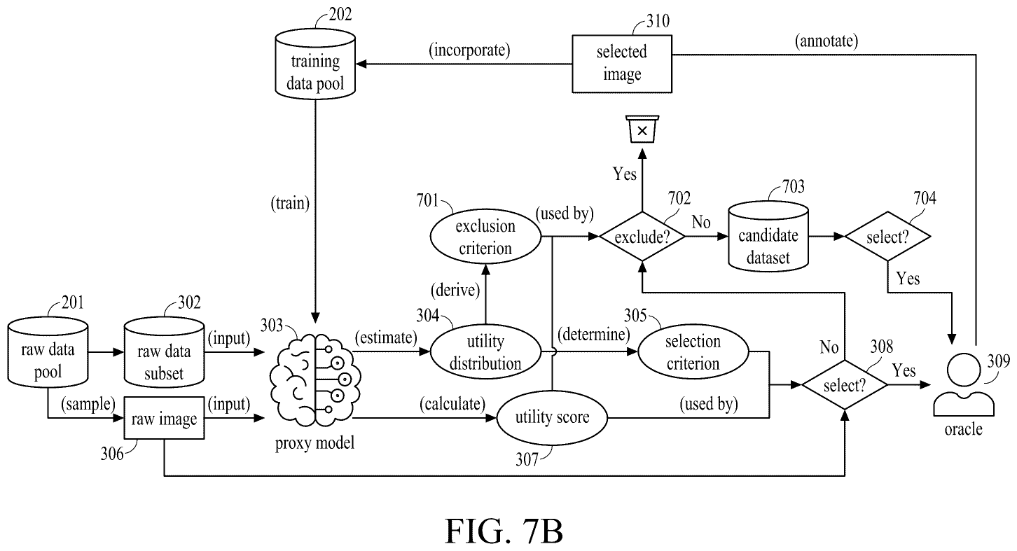

Furthermore, the first selection procedure FSP may involve more operations related to the exclusion criterion, which will be elaborated with reference to FIG. 7A and FIG. 7B hereinafter.

FIG. 7A is the flow diagram of the first selection procedure FSP, according to another embodiment of the present disclosure. As shown in FIG. 7A, the first selection procedure FSP can further include steps S71-S73 in addition to the previously described steps S61-S66. FIG. 7B illustrates the corresponding data flow of the first selection procedure FSP in this embodiment. In view of the strong correlation between FIG. 7A and FIG. 7B, it is recommended to refer to FIG. 7A and FIG. 7B collectively for a clearer understanding of this embodiment.

In step S63, the utility score 307 does not meet the selection criterion 305, the first selection procedure FSP proceeds to step S71. In step S71, it is checked if the utility score 307, which is already confirmed not to meet the selection criterion 305 in step S63, meets the exclusion criterion 701 (e.g., utility score higher than 0.82). If the utility score 307 meets the exclusion criterion 701, the first selection procedure FSP proceeds to step S72, where the raw image 306 is excluded. If the utility score 307 does not meet the exclusion criterion 701, the first selection procedure FSP proceeds to step S73, where the raw image 306 is incorporated into a candidate dataset 703 as a candidate image. Once steps S71, S72, or S73 are completed, the first selection procedure FSP proceeds to step S65, where it is checked whether the number of selected images incorporated into the training data pool 202 has reached the budget for the current iteration.

From the aspect of the data flow as shown in FIG. 7B, a decision 702 is made as to whether the raw image 306 should be excluded or incorporated into the candidate dataset 703. After that, another decision 704 can be made to determine whether certain candidate images in the candidate dataset 703 should be provided to the oracle 309 for annotation.

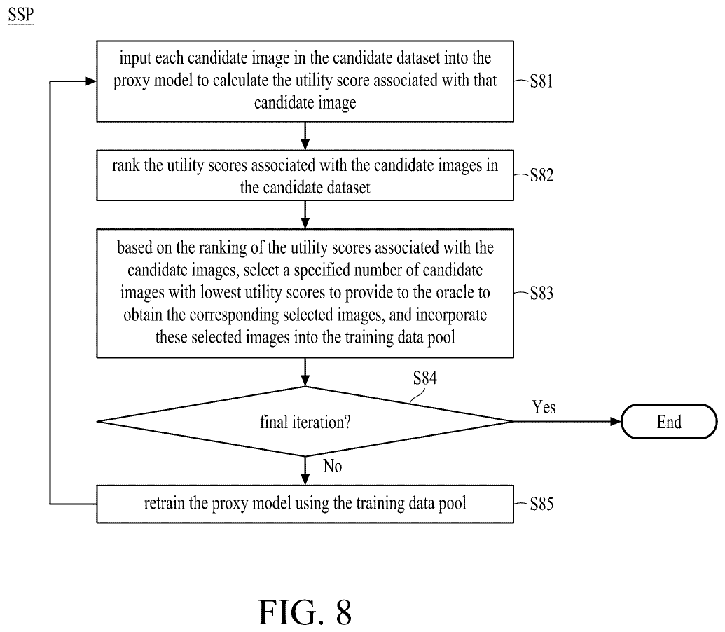

In a further embodiment, in addition to the first selection procedure FSP, the data selection process includes a second selection procedure that is performed for a specified number (at least two) of iterations, which involve the decision 704 illustrated in FIG. 7B. Each iteration of this second selection procedure will be elaborated with reference to FIG. 8.

FIG. 8 is the flow diagram of a second selection procedure SSP, according to a further embodiment of the present disclosure. As shown in FIG. 8, each iteration of the second selection procedure SSP includes steps S81-S85. Since some elements involved in these steps are illustrated in FIG. 7B, it is recommended to refer to FIG. 6 and FIG. 7B collectively for a clearer understanding of this embodiment.

In step S81, each candidate image in the candidate dataset 703 is input into the proxy model 303 to calculate the utility score associated with that candidate image. Then, the second selection procedure SSP proceeds to step S82.

In step S82, the utility scores associated with the candidate images in the candidate dataset 703 are ranked. Then, the second selection procedure SSP proceeds to step S83.

The purpose of ranking utility scores is to identify the images with the lowest utility scores, which are deemed to have the highest potential value or importance for training the target model, as lower utility scores may indicate greater uncertainty, higher diversity, or greater representativeness.

In step S83 (corresponding to the decision 704 illustrated in FIG. 7B), based on the ranking of the utility scores, a specified number of candidate images with the lowest utility scores are selected. These selected candidate images are then provided to the oracle 309 for annotation to obtain the corresponding selected images 310. After being annotated, these selected images 310 are incorporated into the training data pool 202.

In step S84, it is determined whether the current iteration is the final iteration of the second selection procedure SSP. If the current iteration is the final one, the second selection procedure SSP concludes. If the current iteration is not the final one, the second selection procedure SSP loops back to step S81, where the next iteration begins.

In step S85, the proxy model 303 the proxy model 303 is retrained using the newly updated training data pool 202 before returning to step S81 for the next iteration, so as to ensure that the proxy model 303 is continually optimized based on the latest selected and labeled data from the current iteration. As previously described, there are two approaches to implement this retraining: incremental retraining and full retraining, the details of which will not be reiterated herein.

The exclusion criterion 701, candidate dataset 703, and the second selection procedure SSP are designed to address a potential issue that arises when only high-value data is retained for model training. More specifically, if the model is trained exclusively on data deemed “high-value,” it may become less capable of making accurate predictions on the excluded “low-value” data. Over time, this exclusion may result in the “low-value” data becoming more valuable for training, as the model lacks sufficient exposure to this subset of data. This phenomenon can weaken the model's ability to generalize across various data, leading to poor performance on data that it has not adequately learned from. To mitigate this risk, the second selection procedure SSP ensures that the candidate dataset 703, which includes data that does not meet the initial selection criterion 305 but is also not excluded based on the exclusion criterion 701, is given further consideration. By selectively incorporating certain candidate images back into the training process, the model can avoid over-relying on the high-value data while still maintaining a broad learning scope.

In an embodiment, the proxy model comprises a dropout layer in which each neuron is omitted with a specified dropout probability. The dropout layer is designed to help prevent overfitting by forcing the model to rely on different subsets of neurons during each forward pass, thus ensuring that the model does not become overly dependent on specific neurons and improves its robustness when making predictions on new, unseen data. Additionally, the utility score is calculated based on multiple outputs across multiple forward passes of the proxy model. In other words, the evaluation of the utility score for each raw image takes into account the results obtained from several forward passes, each of which may involve different subsets of active neurons due to the random dropout mechanism. By aggregating these outputs, the proxy model can assess the utility of the raw images more reliably, capture more aspects in the model's predictions, and better reflect the potential value of the image for training the target model.

It should be appreciated that the number of forward passes is not limited by the present disclosure. Theoretically, performing more forward passes can result in more accurate utility score estimations, as the model can better capture the variability and uncertainty in its predictions. However, this comes at the cost of higher computational resources. Therefore, a trade-off between accuracy and computational resource consumption should be carefully considered. In a suggested but not limited embodiment, the number of forward passes is set to five.

In an embodiment, the utility score is calculated based on a combination of semantic certainty, spatial certainty, and occurrence certainty associated with the multiple outputs across multiple forward passes of the proxy model. In various implementations, the combination of these certainties may involve summing, multiplying, or applying other mathematical operations to integrate their respective contributions, but the present disclosure is not limited thereto. Furthermore, a flexible approach such as applying weights to different certainties can be adopted depending on the specific application or desired performance criteria.

The semantic certainty represents the proxy model's confidence in predicting the class of an object present in the image, such as cat, dog, or car. More specifically, this semantic certainty is derived from the confidence scores produced by the model when it assigns a class label to the object in the raw image. A higher semantic certainty indicates that the model is more certain that the object belongs to the predicted class. For example, a model predicting a “cat” with 95% confidence would have higher semantic certainty than a model predicting “cat” with 60% confidence. This score is crucial in assessing whether the image is likely to improve the model's understanding of different object categories.

The spatial certainty represents the proxy model's confidence in predicting a spatial extent of the object. This could involve predicting a bounding box, segmentation mask, or other spatial information that defines where the object is located. A high spatial certainty indicates that the model is confident about the object's position and size in the image, whereas a lower spatial certainty indicates uncertainty about the position and/or size of the object. For instance, in an image with a partially occluded car, the model's spatial certainty in correctly predicting the car's full extent might be lower.

The spatial certainty represents the proxy model's confidence in predicting a spatial extent of the object. This could involve predicting a bounding box, segmentation mask, or other spatial information that defines where the object is located. A high spatial certainty indicates that the model is confident about the object's position and size in the image, whereas a lower spatial certainty indicates uncertainty about the position and/or size of the object. For instance, in an image with a partially occluded car, the model's spatial certainty in correctly predicting the car's full extent might be lower.

The occurrence certainty represents the frequency of the object's occurrence in the multiple forward passes of the proxy model. Since the proxy model contains dropout layers, the model may make slightly different predictions with each forward pass. Occurrence certainty measures how consistently the model detects the object across these passes. A high occurrence certainty indicates that the object is consistently detected in every forward pass, suggesting that the object is a significant feature in the image. Conversely, a low occurrence certainty means that the model's detection of the object is sporadic, possibly due to ambiguity or noise in the image.

In an embodiment, the spatial certainty is calculated based on a combination of bounding box certainty and mask certainty. In various implementations, the combination of the bounding box certainty and the mask certainty may involve summing, multiplying, or applying other mathematical operations to integrate their respective contributions, but the present disclosure is not limited thereto.

The bounding box certainty represents the proxy model's confidence in predicting the bounding box of the object, which refers to the rectangular region that encloses the object within the image. A high bounding box certainty indicates that the model is confident in accurately predicting the object's position and size. The mask certainty, on the other hand, represents the proxy model's confidence in predicting the instance segmentation of the object. Instance segmentation involves delineating the exact pixel-wise boundaries of the object, and high mask certainty indicates confidence in precisely identifying the object's contours within the image.

In a further embodiment, the bounding box certainty is measured by the intersection over union (IOU) between the predicted bounding box and an average bounding box, while the mask certainty is measured by the IOU between the predicted instance segmentation and an average instance segmentation. The average bounding box and average instance segmentation are computed as the mean results derived from multiple forward passes of the proxy model, which incorporate variations introduced by dropout. In this context, a larger IOU value indicates a higher degree of overlap between the predicted and average bounding box (or instance segmentation), which in turn reflects greater confidence in the model's predictions. Conversely, a smaller IOU value suggests that there is more discrepancy between the predictions and the average result, indicating lower certainty in the spatial predictions.

The active learning method provided herein offers a significant improvement in computational efficiency by leveraging the evaluation of the utility distribution to establish selection and/or exclusion criteria. As a result, the need to repeatedly calculate utility scores of raw images is drastically reduced, allowing for more efficient data selection while maintaining model performance. According to experimental results, embodiments of this method improve efficiency by at least 27% compared to traditional active learning methods, without compromising model accuracy. The flexibility in defining and applying the selection and/or exclusion criteria further enhances the adaptability to various machine learning tasks, providing an efficient and robust solution for active learning pipelines.

The above paragraphs are described with multiple aspects. Obviously, the teachings of the specification may be performed in multiple ways. Any specific structure or function disclosed in examples is only a representative situation. According to the teachings of the specification, it should be noted by those skilled in the art that any aspect disclosed may be performed individually, or that more than two aspects could be combined and performed.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A computer-implemented method for active learning, comprising:
using a proxy model to estimate a utility distribution of a raw data pool based on a raw data subset obtained from the raw data pool;
determining a selection criterion based on the utility distribution;
performing a data selection process based on the selection criterion, wherein the data selection process comprises using the proxy model to calculate a utility score associated with a raw image from the raw data pool, using the selection criterion to selectively provide the raw image to an oracle to obtain a selected image corresponding to the raw image, and incorporating the selected image into a training data pool, wherein the utility score associated with the raw image provided to the oracle meets the selection criterion; and
using the training data pool to train a target model.

2. The computer-implemented method as claimed in claim 1, wherein the step of using the proxy model to estimate the utility distribution of the raw data pool further comprises inputting each raw image in the raw data subset into the proxy model to calculate the utility score associated with that raw image, and estimating the utility distribution of the raw data pool based on the utility scores associated with the raw images in the raw data subset; and
wherein the step of determining the selection criterion further comprises deriving a cumulative distribution from the utility distribution, and using the cumulative distribution to determine the selection criterion, wherein the selection criterion is associated with a first specified proportion.

3. The computer-implemented method as claimed in claim 2, wherein the data selection process comprises a first selection procedure that is performed for at least two iterations based on the selection criterion, and wherein each iteration of the first selection procedure comprises:
sampling the raw image from the raw data pool;
inputting the raw image into the proxy model to calculate the utility score associated with the raw image; and
checking if the utility score associated with the raw image meets the selection criterion, and providing the raw image to the oracle to obtain the corresponding selected image and incorporate the selected image into the training data pool if so;
wherein the steps of sampling the raw image, calculating the utility score for the raw image, and checking if the utility score associated with the raw image meets the selection criterion are repeated until number of the selected images incorporated into the training data pool in that iteration of first data selection process reaches a specified budget; and
wherein before entering next iteration of the first selection procedure, the proxy model is retrained using the training data pool.

4. The computer-implemented method as claimed in claim 3, wherein the data selection process further comprises using the cumulative distribution to determine an exclusion criterion associated with a second specified proportion, and wherein each iteration of the first selection procedure further comprises:
checking if the utility score associated with the raw image that does not meet the selection criterion meets the exclusion criterion, excluding the raw image if so, and incorporating the raw image into a candidate dataset as a candidate image if not.

5. The computer-implemented method as claimed in claim 4, wherein the data selection process further comprises a second selection procedure that is performed for at least two iterations, and wherein each iteration of the second selection procedure comprises:
inputting each candidate image in the candidate dataset into the proxy model to calculate the utility score associated with that candidate image;
ranking the utility scores associated with the candidate images in the candidate dataset; and
based on the ranking of the utility scores associated with the candidate images, selecting a specified number of candidate images with lowest utility scores to provide to the oracle to obtain the corresponding selected images, and incorporating the selected images into the training data pool;
wherein before entering next iteration of the second selection procedure, the proxy model is retrained using the training data pool.

6. The method as claimed in claim 2, wherein the proxy model comprises a dropout layer which randomly omits each neuron with a specified dropout probability; and
wherein the utility score is calculated based on multiple outputs across multiple forward passes of the proxy model.

7. The method as claimed in claim 6, wherein the utility score is calculated based on a combination of semantic certainty, spatial certainty, and occurrence certainty associated with the multiple outputs, wherein the semantic certainty represents the proxy model's confidence in predicting a class of an object, the spatial certainty represents the proxy model's confidence in predicting a spatial extent of the object, and the occurrence certainty represents a frequency of the object's occurrence in the multiple forward passes of the proxy model.

8. The method as claimed in claim 7, wherein the spatial certainty is calculated based on a combination of bounding box certainty and mask certainty, wherein the bounding box certainty represents the proxy model's confidence in predicting a bounding box of the object, and the mask certainty represents the proxy model's confidence in predicting instance segmentation of the object.

9. The method as claimed in claim 8, wherein the bounding box certainty is measured by an intersection over union (IOU) between the predicted bounding box and an average bounding box; and
wherein the mask certainty is measured by the IOU between the predicted instance segmentation and an average instance segmentation.

10. The method as claimed in claim 1, wherein the raw data subset is obtained from the raw data pool through simple random sampling.

11. A computer system for active learning, comprising:
a processing unit; and
a storage unit, configured to store a raw data pool, a training data pool, and an active learning program, wherein the active learning program comprises instructions that, when executed by the processing unit, cause the computer system to execute steps including:
using a proxy model to estimate a utility distribution of the raw data pool based on a raw data subset obtained from the raw data pool;
determining a selection criterion based on the utility distribution;
performing a data selection process based on the selection criterion, wherein the data selection process comprises using the proxy model to calculate a utility score associated with a raw image from the raw data pool, using the selection criterion to selectively provide the raw image to an oracle to obtain a selected image corresponding to the raw image, and incorporating the selected image into a training data pool, wherein the utility score associated with the raw image provided to the oracle meets the selection criterion; and
using the training data pool to train a target model.

12. The computer system as claimed in claim 11, wherein the step of using the proxy model to estimate the utility distribution of the raw data pool further comprises inputting each raw image in the raw data subset into the proxy model to calculate the utility score associated with that raw image, and estimating the utility distribution of the raw data pool based on the utility scores associated with the raw images in the raw data subset; and
wherein the step of determining the selection criterion further comprises deriving a cumulative distribution from the utility distribution, and using the cumulative distribution to determine the selection criterion, wherein the selection criterion is associated with a first specified proportion.

13. The computer system as claimed in claim 12, wherein the data selection process comprises a first selection procedure that is performed for at least two iterations based on the selection criterion, and wherein each iteration of the first selection procedure comprises:
sampling the raw image from the raw data pool;
inputting the raw image into the proxy model to calculate the utility score associated with the raw image; and
checking if the utility score associated with the raw image meets the selection criterion, and provide the raw image to the oracle to obtain the corresponding selected image and incorporate the selected image into the training data pool if so;
wherein the steps of sampling the raw image, calculating the utility score for the raw image, and checking if the utility score associated with the raw image meets the selection criterion are repeated until number of the selected images incorporated into the training data pool in that iteration of first data selection process reaches a specified budget; and
wherein before entering next iteration of the first selection procedure, the proxy model is retrained using the training data pool.

14. The computer system as claimed in claim 13, wherein the data selection process further comprises using the cumulative distribution to determine an exclusion criterion associated with a second specified proportion, and wherein each iteration of the first selection procedure further comprises:
checking if the utility score associated with the raw image that does not meet the selection criterion meets the exclusion criterion, excluding the raw image if so, and incorporating the raw image into a candidate dataset as a candidate image if not.

15. The computer system as claimed in claim 14, wherein the data selection process further comprises a second selection procedure that is performed for at least two iterations, and wherein each iteration of the second selection procedure comprises:
inputting each candidate image in the candidate dataset into the proxy model to calculate the utility score associated with that candidate image;
ranking the utility scores associated with the candidate images in the candidate dataset; and
based on the ranking of the utility scores associated with the candidate images, selecting a specified number of candidate images with lowest utility scores to provide to the oracle to obtain the corresponding selected images, and incorporating the selected images into the training data pool;
wherein before entering next iteration of the second selection procedure, the proxy model is retrained using the training data pool.

16. The computer system as claimed in claim 12, wherein the proxy model comprises a dropout layer which randomly omits each neuron with a specified dropout probability; and
wherein the utility score is calculated based on multiple outputs across multiple forward passes of the proxy model.

17. The computer system as claimed in claim 16, wherein the utility score is calculated based on a combination of semantic certainty, spatial certainty, and occurrence certainty associated with the multiple outputs, wherein the semantic certainty represents the proxy model's confidence in predicting a class of an object, the spatial certainty represents the proxy model's confidence in predicting a spatial extent of the object, and the occurrence certainty represents a frequency of the object's occurrence in the multiple forward passes of the proxy model.

18. The computer system as claimed in claim 17, wherein the spatial certainty is calculated based on a combination of bounding box certainty and mask certainty, wherein the bounding box certainty represents the proxy model's confidence in predicting a bounding box of the object, and the mask certainty represents the proxy model's confidence in predicting instance segmentation of the object.

19. The computer system as claimed in claim 18, wherein the bounding box certainty is measured by an intersection over union (IOU) between the predicted bounding box and an average bounding box; and
wherein the mask certainty is measured by the IOU between the predicted instance segmentation and an average instance segmentation.

20. The computer system as claimed in claim 11, wherein the raw data subset is obtained from the raw data pool through simple random sampling.
